(19) United States
(12) Patent Application Publication
(10) Pub. No.: US 2024/0006618 A1
(43) Pub. Date: Jan. 4, 2024

(54) ELECTROCATALYST, WITH METHOD OF MAKING AND SYSTEMS INCLUDING THE ELECTROCATALYST

(71) Applicant: CDTi Advanced Materials Inc., Oxnard, CA (US)

(72) Inventor: Ru-Fen LIU, PORT HUENEME, CA (US)

(21) Appl. No.: 18/351,547

(22) Filed: Jul. 13, 2023

Related U.S. Application Data
(63) Continuation-in-part of application No. PCT/US22/78998, filed on Oct. 31, 2022.
(60) Provisional application No. 63/274,224, filed on Nov. 1, 2021.

(51) Int. Cl. H01M 4/90; H01M 4/88

(52) U.S. Cl. CPC H01M 4/9033; H01M 4/8882; H01M 4/88; H01M 4/9075

(57) ABSTRACT

A method for making a bi-metallic electrocatalyst produces a non-platinum group metal (non-PGM), bimetallic oxide crystalline catalyst showing low overpotential in both oxygen evolution reactions (OER) and oxygen reduction reactions (ORR) in a metal-air battery and/or fuel cell applications. The bimetallic oxide is formed to be in electrical communication with a catalyst support particle, and with the catalyst support particle, in turn, in electrical communication with an air-permeable electrode. A metal-air storage cell, optionally configured as part of a battery, includes a bi-metallic electrocatalyst. An electrical management system includes a metal-air storage cell.

### CROSS REFERENCE TO RELATED APPLICATIONS

The present application is a Continuation-in-Part application which claims priority benefit under 35 U.S.C. § 120 of co-pending International Patent 10 Application No. PCT/US2022/78998, entitled “ELECTROCATALYST, METHOD OF MAKING THE ELECTROCATALYST, AND SYSTEMS INCLUDING THE ELECTROCATALYST,” filed Oct. 31, 2022 (docket number 3082-002-04); which claims priority benefit from U.S. Provisional Patent Application No. 63/274,224, entitled “ELECTROCATALYST AND METHOD OF MAKING,” filed 15 Nov. 1, 2021 (Docket Number 3082-002-02), now expired. Each of the foregoing applications, to the extent not inconsistent with the disclosure herein, is incorporated by reference.

### SUMMARY

According to an embodiment, a method for making a bi-metallic electrocatalyst includes adding, to a water solution, a first organometallic compound, nAR¹ₓ, a second organometallic compound rnBR²_{y} in a ratio m/n to the first organometallic compound, and a quantity of catalyst support particles. A condition is created in the water solution to cause the metals A, B to dissociate from their respective ligands R¹, R², while associating with a hydroxide counter ion to form metal hydroxides A(OH)ₓ and B(OH)_{y}, as an intermediate catalyst, and optionally adhere the metal hydroxides to the catalyst support particles as an intermediate catalyst and catalyst support complex. The water solution precipitates the intermediate catalyst and optional catalyst support complex out of solution as a catalyst precipitate complex. The catalyst precipitate complex is dried and may be calcined according to a temperature schedule selected to convert the metal hydroxides to crystalline metal oxides disposed in small particles. The crystalline metal oxides may include two non-platinum group metal oxides in crystalline form.

Embodiments provide processes for preparing catalyst structures and compositions required to activate bi-functional oxygen reduction and oxygen evolution reactions in alkaline-based fuel cells and/or in metal-air batteries, such as a zinc-air battery.

According to an embodiment, a metal-air storage cell includes a package defining an inner volume with an electrode including a base metal disposed in the inner volume, the electrode including a first electrode portion configured for electrical coupling to a system outside the package. An electrolyte is disposed in the inner volume and operatively coupled to the base metal electrode. A porous second electrode is configured to admit oxygen from a region external to the package. The porous second electrode includes a second electrode portion configured for electrical coupling to the system outside the package. A gas diffusion substrate is disposed between the porous cathode and the electrolyte and a catalyst is disposed adjacent to the gas diffusion substrate, contacting the electrolyte.

According to an embodiment, a power management system includes a metal-air storage cell, optionally in the form of a battery. The power management system may include an electrical power generation system and a switch operatively coupled to the metal-air storage cell, the electrical power generation system, and an electrical load.

According to an embodiment, an electrocatalyst is made according to methods described herein. The electrocatalyst may be in the form of ink suitable for printing onto a gas diffusion substrate for use in a metal-air battery or other alkaline system.

According to an embodiment, a component for a metal-air battery includes a gas diffusion substrate and an electrocatalyst made according to methods described herein printed on a surface of the gas diffusion substrate. The gas diffusion substrate may be die-cut to a size corresponding to a porous electrode for a metal-air battery.

According to an embodiment, a method for making a metal-air storage cell includes printing a catalyst made according to methods described herein onto a gas diffusion substrate and assembling the printed gas diffusion substrate to be disposed adjacent to a conductive porous electrode in a metal air storage cell.

### BRIEF DESCRIPTION OF THE DRAWINGS

FIG. 1 is a flow-chart showing a method for making a bi-metallic electrocatalyst, according to an embodiment FIG. 2 is a diagram of a metal-air electrical storage cell including the electrocatalyst made according to the method of FIG. 1, according to an embodiment.

FIG. 3 is a block diagram of a power management system including the metal-air storage cell of FIG. 2, according to an embodiment.

FIG. 4 is a graph summarizing overpotential data corresponding to selected non-PGM catalyst materials, according to an embodiment.

FIG. 5 illustrates overpotential values for a non-PGM catalyst composition as a function of catalyst mass loading, according to an embodiment.

FIG. 6 is a graphical depiction of overpotential comparisons between catalysts described herein against a state-of-the-art platinum group metal (PGM) catalyst, according to an embodiment.

FIG. 7 is a graphical depiction of overpotential changes as a function of cycles for ORR and OER reactions as a durability test, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

Embodiments described herein relate to a discovery that precious metal-free catalyst structures are unique as providing excellent pore structure that allows efficient gas diffusion capability. In addition, catalysts described herein are active both for oxygen evolution reactions (OER) and for oxygen reduction reactions (ORR) that respectively occur during discharging and charging cycles of use. Such reactions may take place in three phases of matter, gas, liquid, and solid surface.

A unitized reversible fuel cell (URFC) is an energy storage device that may provide continuous operation and switching between charging and discharging half-cycles. This may represent important technology to advance energy efficiency for a large grid energy storage system. The demand of clean energy solutions to mitigate the reliance of fossil fuel-based technology challenges us to speed up the innovation. Enabling the technology scaleup becomes critical for energy transition. All above-mentioned technologies are facing scaleup challenge in order to drive the energy production cost down and to compete with current cheap and large-scale energy production using fossil. One of the key challenges is that the cathode/anode materials that require to meet performance are expensive. For instance, the use of precious metal in a proton exchange membrane (PEM)-based reversible fuel cell (RFC) makes the technology even more challenging when scale up. On the other hand, an alkaline-based cell is known to allow non-precious metal materials to catalyze the reactions in the cell. This property makes the alkaline-based energy storage technologies more intrigued for accelerating the technology scale up. It is thus desirable to develop a non-platinum group metal (non-PGM) oxygen electrode catalyst that offers high activity and durability in an alkaline cell device, such as a metal-air battery.

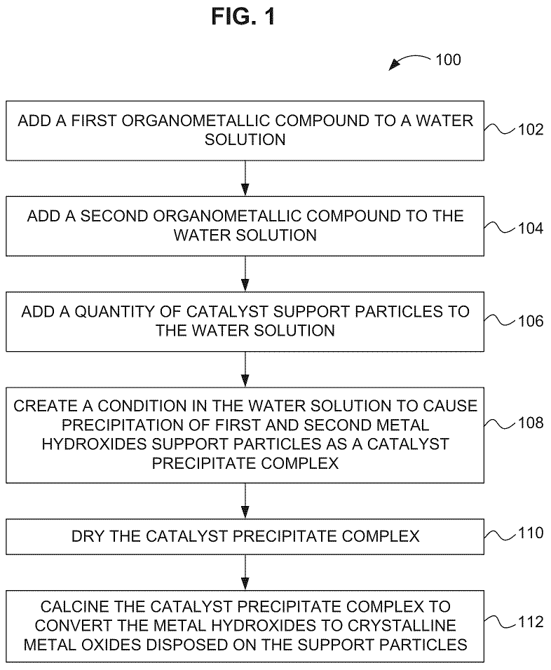

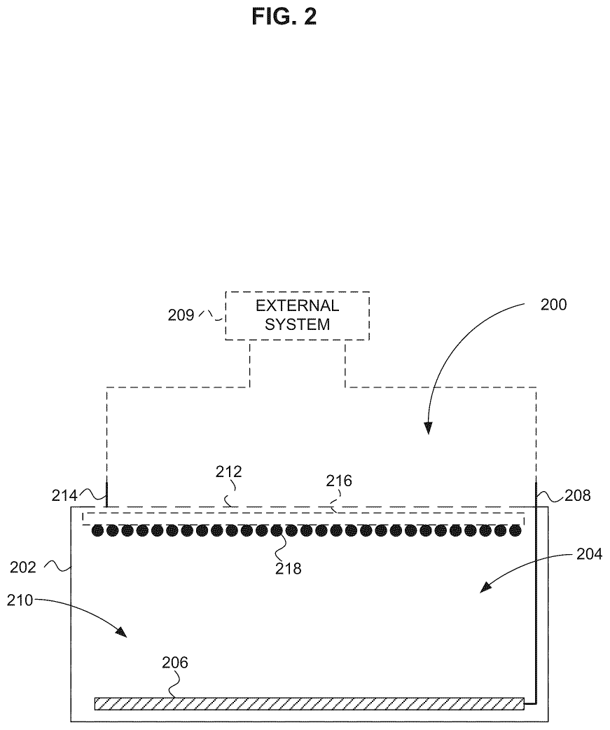

FIG. 1 is a flow chart showing a method 100 for making a non-PGM oxygen electrode catalyst, according to an embodiment. According to an embodiment, the method 100 for making a non-platinum group metal (non-PGM) oxygen electrode catalyst, in the form of a bi-metallic electrocatalyst, includes, in step 102 adding, to a water solution, a first organometallic compound, nAR¹ₓ, and, in step 104, a second organometallic compound mBR²_{y} in a ratio m/n to the first organometallic compound. The method for making the non-PGM oxygen electrode catalyst may optionally include adding to the water solution in step 106, a quantity of catalyst support particles. In step 108, a condition is created in the water solution to cause the metals A, B to dissociate from their respective ligands R¹, R², and associate with a hydroxide counter ion to form metal hydroxides A(OH)ₓ and B(OH)_{y}, as an intermediate catalyst. The method may optionally include adhering the metal hydroxides to the catalyst support particles as an intermediate catalyst and catalyst support complex. The condition created in the water solution may optionally precipitate the intermediate catalyst and catalyst support complex out of solution as a catalyst precipitate complex. In step 110, the catalyst precipitate complex may be dried. In step 112, the catalyst precipitate complex may be further calcined to convert the metal hydroxides to crystalline metal compounds including oxides, optionally disposed on the support particles, the crystalline metal oxides including two non-platinum group metal oxides in crystalline form.

The crystalline metal compound disposed on the catalyst support particle (or optionally, without the catalyst support particle) forms a bi-metallic, bi-functional electrocatalyst. The bi-functionality refers to catalysis of both oxygen reduction reactions (ORR) and oxygen evolution reactions (OER) during respective half-cycles.

The crystalline metal oxide may be selected from the group consisting of an oxide of Ni—Co, an oxide of Co—Mn, an oxide of Ni—Fe, an oxide of Co—Cr, an oxide of Ni—Cr, an oxide of La—Ti, an oxide of La—Ni, an oxide of La—Co, an oxide of La—Fe, an oxide of Sr—Nb, and an oxide of Sr—Ti wherein the m/n is between 0.01 and 30. In some embodiments, m/n is between 0.2 and 25. In some embodiments, the crystalline metal oxide includes a spinel-type crystal. The crystalline metal oxide may have a formula AB₂O₄, wherein A is nickel (Ni) and B is cobalt (Co) or iron (Fe). The crystalline metal oxide may additionally or alternatively include a Perovskite-type crystal. In a Perovskite-type crystal, the crystalline metal oxide may have a formula ABO₃, wherein A is lanthanum (La) and B is cobalt (Co) or nickel (Ni). In other embodiments, the crystalline metal oxide may include a Delefossite-type crystal or a Brookite-type crystal.

In an embodiment, R¹ and R² are the same ligand, such as when each of R¹ and R² are nitro groups. The ligands R¹ and R² may additionally or alternatively, independently at each occurrence, include an alkyl group, a substituted alkyl group, an alcoxide, a nitro-alcoxide, a nitro group, a carbonate, or an acetate.

The method for making the bi-metallic electrocatalyst may include etching the catalyst support particles to increase available surface area. The method may include crosslinking the catalyst support particles to increase the available pore structure. The method may include evaporating the solution to leave a hydrate form of the precipitate complex.

The condition created in the water solution may include changing pH. The condition created in the water solution may include adding ammonium compound or alkali hydroxide to the water solution. The condition created in the water solution may include changing temperature of the water solution. The condition created in the water solution may include changing ambient pressure in the water solution. The condition created in the water solution may include evaporating the water solution to increase the metal hydroxide concentrations in the water solution above a saturation limit. The condition created in the water solution may include maintaining the water solution quiescent while aging the water solution sufficiently to crystallize the metal hydroxide onto the catalyst support particle.

In an embodiment, precipitating the precipitate complex out of solution occurs prior to drying.

The catalyst and/or catalyst support complex may generally be conductive.

According to an embodiment, catalyst support particles may include carbon, such as carbon black. The carbon may be non-functionalized.

Alternatively, the catalyst support particles may be a non-carbon material. In an embodiment, non-carbon catalyst support particles include iridium oxide (IrO₂) and/or ruthenium oxide (RuO₂).

In another embodiment, the non-carbon catalyst support material may include a doped inorganic oxide. The doped inorganic oxide may include titanium oxide (TiO₂), tin oxide (SnO₂), and/or zirconium oxide (ZrO₂). The dopant may include antimony (Sb) and/or indium (In).

In another embodiment, the non-carbon catalyst support material includes a sub-stoichiometric oxide of titanium (as TiOₙ) or zirconium (as ZrOₙ), where 1<n<2.

A sub-stoichiometric oxide may be formed by partially calcining a precipitate of the titanium or zirconium under an oxygen-containing atmosphere, purging the oxygen-containing atmosphere with an inert gas, and partially calcining the precipitate of titanium or zirconium under the inert gas.

In another embodiment, the non-carbon catalyst support material includes a spinel. The spinel may include nickel and cobalt and/or nickel and iron, for example. In the case of a spinel catalyst support particle, template-formed crystallization may be enhanced.

According to embodiments, the non-carbon catalyst support material forms an electrically conductive material for maximization of catalyst reactivity. According to embodiments, the non-carbon catalyst support material may be characterized by a particle size of 20 to 200 nanometers.

FIG. 2 is a block diagram of a metal-air storage cell including the electrocatalyst made according to the method of FIG. 1, according to an embodiment. The metal-air storage cell 200 includes a package 202 defining an inner volume 204; an electrode such as an anode 206 including a base metal disposed in the inner volume 204, the electrode 206 including a first electrode portion 208 configured for electrical coupling to a system 209 outside the package; and an electrolyte 210 disposed in the inner volume 204 and operatively coupled to the base metal electrode. A porous second electrode such as a cathode 212 is configured to admit oxygen from a region external to the package, the porous second electrode 212 including a second electrode portion 214 configured for electrical coupling to the system 209 outside the package. A gas diffusion substrate 216 may be disposed between the porous second electrode and the electrolyte 210. A catalyst 218 made according to the method of FIG. 1 is disposed adjacent to the gas diffusion substrate 216.

The catalyst 218 may include a conductive catalyst support and a binary or greater set of catalytic metal particles, the binary or greater set of metal particles being configured to form binding sites operative to reduce an energy barrier at least to discharging the metal-air storage cell. According to embodiments, the catalyst 218 is operative to reduce an energy barrier to both charging and discharging the metal-air storage cell.

The binary or greater set of catalytic metal particles may be configured to operate in adatom catalytic binding to transport electrons from oxygen to reduce an oxidized state of the base metal during charging and to transport electrons away from a reduced state of the base metal to oxidize the base metal during discharging.

According to an embodiment, the base metal includes zinc.

The gas diffusion substrate 216 may be selected to prevent the electrolyte 210 from escaping from the inner volume 204 to the external region; allow oxygen diffusion from the external region to the electrolyte 210 proximate to the catalyst 218 during discharging of the metal-storage cell 200; allow oxygen diffusion from the electrolyte 210 proximate to the catalyst 218 to the external region during charging of the metal-storage cell 200; and conduct electricity between the electrolyte 210 proximate to the catalyst 218 and the porous cathode 212.

The gas diffusion substrate 216 may include carbon or other conductive material. For example, the carbon may be coated onto polyolefin fibers previously or subsequently formed into a non-woven sheet of material. In an embodiment, the gas diffusion substrate includes a micro-porous material. The gas diffusion substrate may form a hydrophobic sheet. For example, the gas diffusion substrate may include porous graphite fibers, titanium fibers or silicon oxycarbide fibers.

The catalyst 218 may be prepared as an ink and printed onto an inner surface of the gas diffusion substrate 216 during manufacture, the ink being subsequently dried prior to assembly of the metal-air storage cell 200.

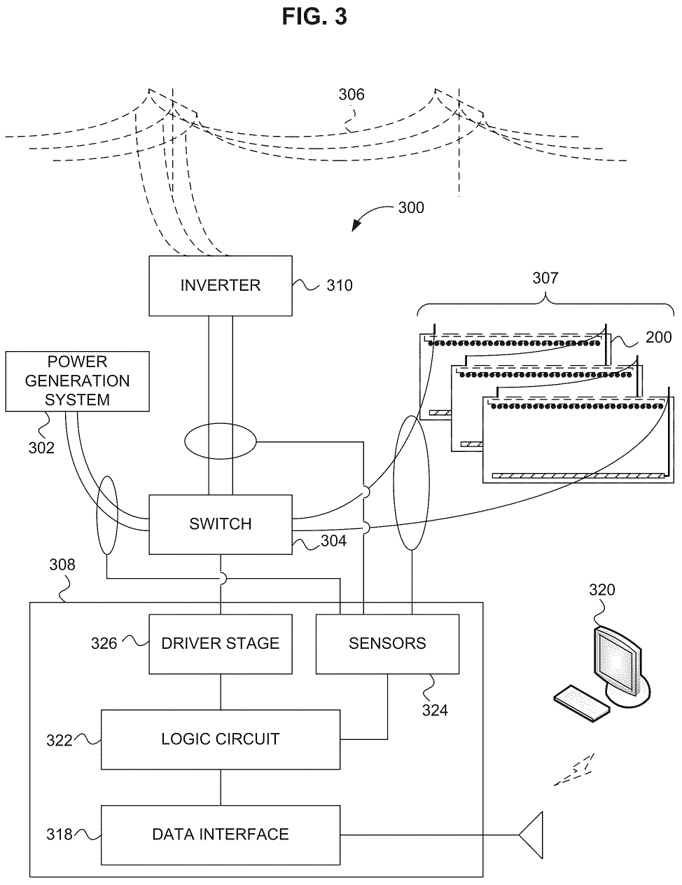

FIG. 3 is a diagram of a power management system 300 including a metal-air storage cell of FIG. 2, the metal-air storage cell including the electrocatalyst made according to the method of FIG. 1, according to an embodiment.

The power management system 300 may include a metal-air storage cell 200 including an electrocatalyst made according to the method of FIG. 1. The metal-air storage cell may be made according to the structure of FIG. 2. The power management system may further be operatively coupled to and/or may include an electrical power generation system 302 and a switch 304 operatively coupled to the metal-air storage cell 200, the electrical power generation system 302, and an electrical load 306.

The metal-air storage cell 200 may be provided as a metal-air battery 307 formed from a plurality of cells 200.

The switch 304 may be configured to conduct electrical power from the electrical power generation system 302 to the electrical load 306 and/or the metal-air storage cell 200.

The power management system 300 may further include an electrical inverter 310 operatively coupled to the electrical load 306 and the switch 304, the electrical inverter 310 being configured to convert DC electrical current from the metal-air storage cell 200 and/or the electrical power generation system 302 to AC electrical current delivered to the electrical load 306. Optionally, the electrical inverter 310 may be disposed between the metal-air storage cell 200 and the switch 304, and another electrical inverter disposed between the electrical power generation system 302, such that the switch 304 makes and breaks AC current.

The power management system 300 may further include a digital controller 308 operatively coupled to the switch 304, to the electrical load 306, and to the metal-air storage cell 200, the digital controller 308 being configured to actuate the switch 304. The digital controller 308 may be configured to connect the power generation system 302 to the storage cell 200 and/or the electrical load responsive to a sensed current flow to the load, a sensed power generation from the power generation system 302, and/or a sensed charge state of the storage cell 200.

The digital controller 308 may be configured to actuate the switch 304 to connect the electrical load 306 to the metal-air storage cell 200 when electrical demand from the electrical load 306 exceeds electrical power output by the power generation system 302

The digital controller 316 may include a data interface 318 operatively coupled to an external system 320 such as a computer or server that generates control commands for the digital controller 316. The digital controller 316 may be configured to control the switch 314 to provide electrical continuity between the electrical load 306 and the electrical power generation system 302 and/or provide electrical continuity between the electrical load 306 and the metal-air storage cell 200 for delivery of current to the electrical load 306 responsive to data received from an operatively coupled computer or server 320 via the data interface 318.

The electrical power generation system 302 may include a solar panel, a wind turbine, or other intermittent electrical power source. The metal-air storage cell may thus provide for uninterrupted power from the system 300 to the electrical load 306.

The digital controller 308 may include a logic circuit 322 configured to receive, via a sensor interface 324 or from the computer or server 320, measured power availability from the electrical power generation system 302 and from the metal-air storage cell 200. The logic circuit 322 may further receive measured electrical demand from the electrical load 306. The logic circuit 322 may select one or more electrical current paths between the electrical power generation system 302, the metal-air storage cell 200, and/or the electrical load 306. The digital controller may be configured to drive, with a driver circuit 326, one or more relays or switches 304 to make or break the selected one or more electrical current paths.

The electrical load 306 may include a home, an office, or an off-grid electrical load. The electrical load may include an electrical grid. In another embodiment, the electrical load includes a motive power system for a vehicle, locomotive, or other mobile system, and the electrical power generation system 302 includes an energy recovery system from the mobile system.

According to an embodiment, an electrocatalyst is made according to the method of FIG. 1. The electrocatalyst may be in the form of ink suitable for printing onto a gas diffusion substrate for use in a metal-air battery.

According to an embodiment, a component for a metal-air battery includes a gas diffusion substrate and an electrocatalyst made according to the method of FIG. 1 printed on a surface of the gas diffusion substrate. The gas diffusion substrate may be die-cut to a size corresponding to a porous electrode for a metal-air battery. The gas diffusion substrate may include a non-woven material with a conductive coating.

According to an embodiment, a method for making a metal-air storage cell includes printing a catalyst made according to the method of FIG. 1 onto a gas diffusion substrate and assembling the printed gas diffusion substrate to be disposed adjacent to a conductive porous electrode in a metal air storage cell.

### EXAMPLES

Specific embodiments may be made by reference to the following examples:

The process of making a non-PGM, crystalline catalyst for use as an oxygen electrode catalyst includes 1) selecting a pair of metal nitrate precursors, 2) mixing amounts of the metal nitrates to dissolve in an alkaline solution including a catalyst support material in suspension, 3) reacting the metal nitrates to form metal hydroxides, 4) precipitating the metal hydroxides and support material out of solution while driving off liquid to form crystalline metal oxides on the support material, and 5) calcining the precipitate to convert the metal hydroxides to crystalline metal oxides to form a dry powder including (spinel-type, Perovskite-type, Delafossite-type, and/or Brookite-type) crystals of the pair of metals on the catalyst support material.

Various metal oxide pairs may be formed as catalysts. For example, metal nitrate precursors including metals such as Manganese (Mn), Cobalt (Co), Nickel (Ni), Iron (Fe), Chromium (Cr), Titanium (Ti), Vanadium (V), Niobium (Nb), Lanthanum (La), Strontium (Sr), Lithium (Li), Silver (Ag), and Copper (Cu) may be combined to form non-PGM catalysts. In an embodiment, the selected metal nitrates are mixed with carbon black such as Vulcan XC72R (available from Cabot Corporation, Billerica, MA U.S.A.), BP2000 (also available from Cabot Corporation) or graphite as a conductive catalyst support. Metal hydroxide pairs were disposed on the catalyst support, referred to as a catalyst precipitate complex herein, were formed during evaporation. The catalyst intermediate was then calcined in air at a series of stepped elevated temperatures to drive of water and form metal oxide crystalline forms.

The process of making the catalyst also involved co-precipitation of selected metal nitrate with base solutions such as 1-2M of NaOH or less than 30% of ammonium hydroxide solution. The precipitant was collected and dry in the N₂ purged oven at 120° C. for 6 hours then calcination in air or under the inert atmosphere at increasing temperature steps for 2 hours.

The process of making the catalyst involved spray deposition of the metal precursor onto a glassy plate, and the plate was placed in the oven under 02 atmosphere at 120° C. for 6 hours, slowly to heat under inert to 500° C. with the rate of 1-10° C./min.

Selected binary A-B metal nitrates of Ni—Co, Co—Mn, Ni—Fe, Co—Cr, Ni—Cr families were prepared according to the mole ratios x=A/B, 0<x<20, in processes described herein. Additionally, or alternatively, binary ratios may be reversed, such that Co—Ni, Mn—Co, Fe—Ni, Cr—Co and/or Cr—Ni A-B metal nitrates are prepared according to the mole ratios x=A/B, 0<x<20, in processes described herein.

An “ink solution” was prepared by mixing the carbon-supported catalyst with Nafion™ solution (e.g., Nafion (e.g., D520 or D521) (5 wt % in water)): ultrapure water: and isopropyl alcohol in the ratio of 0.2:4:10 by weight. The “ink solution” was sonicated in a cold ultrasound bath for 1 hour.

The ink was then spin cast onto a glassy carbon rotating disk electrode (RDE) with 9 mm² electrode area. The volume of ink was about 4 μL. To ensure uniformity, the RDE was held in a nitrogen-blanketed rotating station at 700 revolutions per minute speed at room temperature for 20 minutes. The nitrogen-blanket was maintained to ensure no residual oxygen in the catalyst, which otherwise may have confounded oxygen reduction reaction or oxygen evolution reaction results. The dried electrode was then used for testing in a three electrode RDE setup according to a linear sweep cyclic voltammetry (LSCV) test protocol.

The LSCV system including a three electrode RDE system was set up by coupling a saturated calomel electrode (SCE) as a reference electrode, coupling a platinum electrode as a counter electrode and coupling the RDE as the working electrode, wherein the RDE is positioned to rotate through an electrolyte and through an air atmosphere every half-cycle. The electrolyte is prepared as 0.1 M KOH, and the solution was purged by ultrahigh purity of O₂ for at least 1 hour.

The LSCV test protocol was adapted to measure OER and ORR activities. Voltage was scanned from −0.7 to 1V and 1V to −0.7V, cyclically with respect to the SCE, at a 5 mV/sec ramp rate. An oxygen evolution reaction was driven by portions of the positive voltage part of the cycle and an oxygen reduction reaction was enabled by portions of the negative voltage part of the cycle. Data was not taken until after five full cycles of ORR and OER. Measurements were made as voltage vs. current at the RDE vs. the reference electrode to determine overpotential.

Overpotential represents reduced output voltage during an OER (discharge) and an increased required input voltage during an ORR (recharge) compared to thermodynamic ideal voltages. Minimization of combined overpotential is a target for efficient electrochemical reaction systems.

OER overpotential η_{OER} was taken as the voltage obtained at a 10 mA/cm 2 current density at the reference electrode. ORR overpotential η_{ORR} was taken as the voltage obtained at a −3 mA/cm 2 current density at the reference electrode. The bi-functional overpotential was defined as the voltage deference between η_{OER} and η_{ORR}.

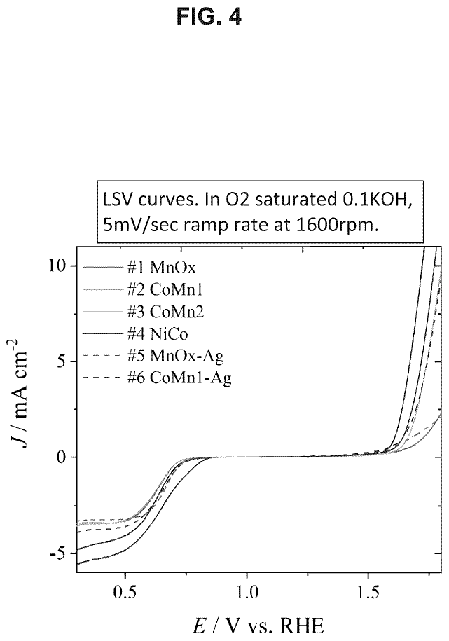

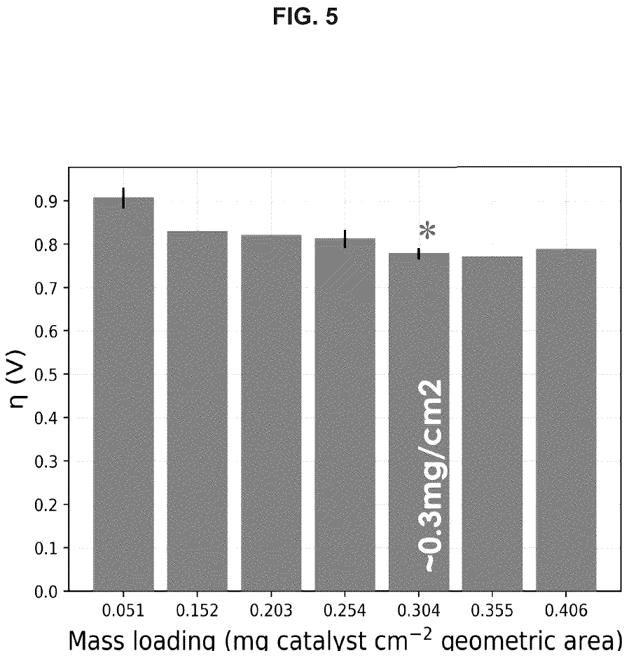

LSCV experiments were run using spinel-type catalyst materials, mixed spinels and oxides, and mixed oxide. LSCV data sets were examined consistently according to above procedure. Results are shown in FIGS. 4 and 5.

Materials that contain nickel-cobalt and nickel-iron showed exceptionally high current ORR and OER activity, respectively. One example with 1:2 ratio of nickel and cobalt with carbon support was found to be the most active. The lowest bi-functional (OER/ORR) overpotential was found to be 0.764V. Another test run with 1:5 nickel:cobalt ratio showed 0.788V of bifunctional overpotential.

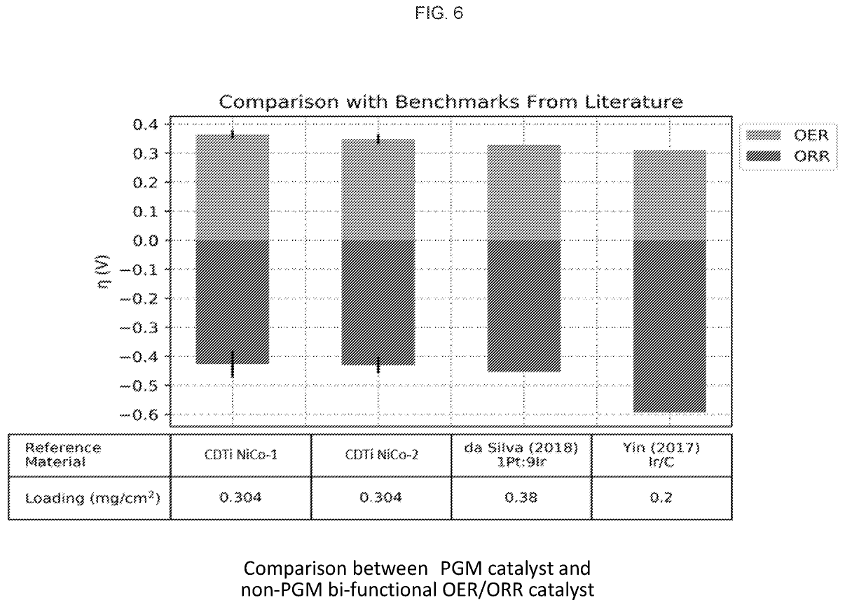

FIG. 6 is a graphical depiction of overpotential comparisons between catalysts described herein against a state-of-the-art platinum group metal (PGM) catalyst, according to an embodiment.

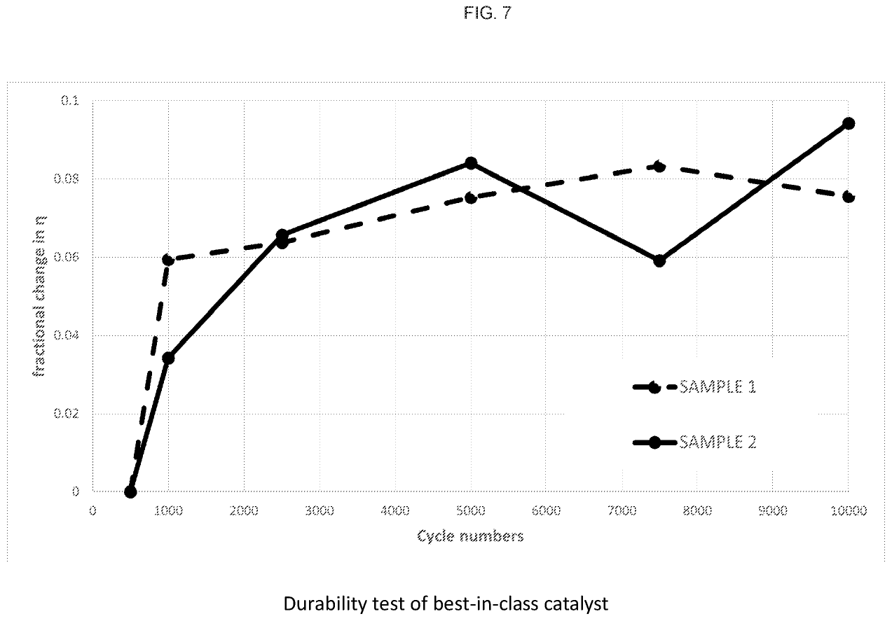

A durability test was performed separately for ORR and OER half-cycles. For testing the ORR half-cycle durability, corresponding to a discharge portion of a metal-air cell, a 50 mV/sec ramp rate was used. For testing the OER half-cycle a 100 mV/sec ramp rate was used. Durability tests for the OER half-cycle were performed without rotating the catalyst-coated test electrode. This approach was taken to minimize chances of the catalyst mechanically falling from the glassy carbon electrode surface (due to formation of an oxygen bubble). The OER and ORR electroactivities were measured after the 500^{th}, 1000^{th}, 2500^{th}, 4500^{th}, 7500^{th} and 10000^{th} full cycles. Durability test results are shown in FIG. 7.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A method for making a bi-metallic electrocatalyst, comprising:
adding, to a water solution, a first organometallic compound, nAR¹ₓ;
adding, to the water solution, a second organometallic compound mBR²_{y} in a ratio m/n to the first organometallic compound;
adding, to the water solution, a quantity of catalyst support particles;
creating a condition in the water solution for at least a portion of the metals A, B to:
dissociate from their respective ligands R¹, R²,
associate with a hydroxide counter ion to form metal hydroxides A(OH)ₓ and B(OH)_{y},
adhere the metal hydroxides to the catalyst support particles as an intermediate catalyst and catalyst support complex, and
precipitate the intermediate catalyst and catalyst support complex out of solution as a catalyst precipitate complex;
drying the catalyst precipitate complex; and
calcining the catalyst precipitate complex to convert the metal hydroxides to crystalline metal oxides disposed on the support particles, the crystalline metal oxides comprising two non-platinum group metal oxides in crystalline form;
wherein:
A is a first metal selected from the group consisting of manganese, cobalt, nickel, iron, chromium, titanium, vanadium, niobium, silver and copper;
B is a second metal, different from the first metal, selected from the group consisting of manganese, cobalt, nickel, iron, chromium, titanium, vanadium, niobium, lanthanum, strontium, lithium, silver and copper;
R¹ is a ligand associated with the first metal;
R² is a ligand associated with the second metal;
x is equal to an oxidation state of the first metal;
y is equal to an oxidation state of the second metal; and
0.01<m/n<30.

2. The method for making a bi-metallic electrocatalyst of claim 1, wherein the crystalline metal oxide disposed on the catalyst support particle comprises a bi-functional electrocatalyst, the bifunctionality referring to catalysis of both oxygen reduction reactions (ORR) and oxygen evolution reactions (OER) during respective half-cycles.

3. The method for making a bi-metallic electrocatalyst of claim 1, wherein the crystalline metal oxide is selected from the group consisting of an oxide of Ni—Co, an oxide of Co—Mn, an oxide of Ni—Fe, an oxide of Co—Cr, and an oxide of Ni—Cr.

4. The method for making a bi-metallic electrocatalyst of claim 1, wherein m/n is between 0.2 and 25.

5. The method for making a bi-metallic electrocatalyst of claim 1, wherein the crystalline metal oxide comprises a spinel-type crystal.

6. The method for making a bi-metallic electrocatalyst of claim 1, wherein the crystalline metal oxide has a formula AB₂O₄.

7. The method for making a bi-metallic electrocatalyst of claim 6, wherein A is nickel (Ni) and B is cobalt (Co).

8. The method for making a bi-metallic electrocatalyst of claim 6, wherein A is nickel (Ni) and B is iron (Fe).

9. The method for making a bi-metallic electrocatalyst of claim 1, wherein the crystalline metal oxide comprises a Perovskite-type crystal.

10. The method for making a bi-metallic electrocatalyst of claim 1, wherein the crystalline metal oxide has a formula ABO₃; and
wherein A is lanthanum (La) and B is cobalt (Co).

11. The method for making a bi-metallic electrocatalyst, of claim 1, wherein the crystalline metal oxide has a formula ABO₃; and
wherein A is lanthanum (La) and B is nickel (Ni).

12. The method for making a bi-metallic electrocatalyst, of claim 1, wherein the crystalline metal oxide includes a Delafossite-type crystal.

13. The method for making a bi-metallic electrocatalyst, of claim 1, wherein the crystalline metal oxide includes a Brookite-type crystal.

14. The method for making a bi-metallic electrocatalyst, of claim 1, wherein R¹ and R² are, independently at each occurrence, an alkyl group, a substituted alkyl group, an alcoxide, a nitro-alcoxide, a nitro group, a carbonate, or an acetate.

15. The method for making a bi-metallic electrocatalyst, of claim 1, wherein R¹ and R² are each the same ligand.

16. The method for making a bi-metallic electrocatalyst, of claim 15, where R¹ and R² are nitro groups.

17. The method for making a bi-metallic electrocatalyst, of claim 1, further comprising, with the water solution, etching the catalyst support particles to increase available surface area.

18. The method for making a bi-metallic electrocatalyst, of claim 1, further comprising, with the water solution, causing crosslinking the catalyst support particles to increase available pore structure.

19. The method for making a bi-metallic electrocatalyst, of claim 1, further comprising: evaporating the solution to leave a hydrate form of the precipitate complex.

20. The method for making a bi-metallic electrocatalyst, of claim 1, wherein creating the condition in the water solution includes changing a pH of the water solution.

21-28. (canceled)

29. The method for making a bi-metallic electrocatalyst, of claim 1, wherein catalyst support particle is conductive.

30. The method for making a bi-metallic electrocatalyst, of claim 1, wherein catalyst support particle comprises non-functionalized carbon.

31-32. (canceled)

33. The method for making the bi-metallic electrocatalyst of claim 1, wherein the catalyst support particle is a non-carbon material.

34. The method for making the bi-metallic electrocatalyst of claim 33, wherein the non-carbon catalyst support material includes at least one selected from the group consisting of iridium oxide (IrO₂) and ruthenium oxide (RuO₂).

35. The method for making the bi-metallic electrocatalyst of claim 33, wherein the non-carbon catalyst support material includes a doped inorganic oxide.

36. The method for making the bi-metallic electrocatalyst of claim 35, wherein the doped inorganic oxide includes an inorganic oxide selected from the group consisting of titanium oxide (TiO₂), tin oxide (SnO₂), and zirconium oxide (ZrO₂).

37. The method for making the bi-metallic electrocatalyst of claim 35, wherein the dopant includes at least one selected from the group consisting of antimony (Sb) and indium (In).

38. The method for making the bi-metallic electrocatalyst of claim 33, wherein the non-carbon catalyst support material includes a sub-stoichiometric oxide of titanium (as TiOₙ) or zirconium (as ZrOₙ);
wherein 1<n<2.

39. The method for making the bi-metallic electrocatalyst of claim 38, wherein the sub-stoichiometric oxide is formed by partially calcining a precipitate of the titanium or zirconium under an oxygen-containing atmosphere, purging the oxygen-containing atmosphere with an inert gas, and partially calcining the precipitate of titanium or zirconium under the inert gas.

40. The method for making the bi-metallic electrocatalyst of claim 33, wherein the non-carbon catalyst support material includes a spinel.

41. The method for making the bi-metallic electrocatalyst of claim 40, wherein the spinel includes at least one selected from the group consisting of a spinel of nickel and cobalt and a spinel of nickel and iron.

42. The method for making the bi-metallic electrocatalyst of claim 33, wherein the non-carbon catalyst support material is characterized by a particle size of 20 to 200 nanometers.

43-65. (canceled)
